(19) United States
(12) Patent Application Publication
(10) Pub. No.: US 2017/0110757 A1
(43) Pub. Date: Apr. 20, 2017

(54) APPARATUS AND METHOD FOR TRANSPORTING ELECTROCHEMICAL CELLS

(71) Applicant: Genius Patentverwertung GmbH & Co. KG, Königs Wusterhausen (DE)

(72) Inventor: Klaus-Michael PASEWALD, Blankenfelde (DE)

(73) Assignee: Genius Patentverwertung GmbH & Co. KG, Königs Wusterhausen (DE)

(21) Appl. No.: 15/127,212

(22) PCT Filed: Mar. 19, 2015
(86) PCT No.: PCT/EP2015/055806

§ 371 Date: Sep. 19, 2016

(30) Foreign Application Priority Data
Mar. 21, 2014 (DE) 10 2014 103 928.9

(51) Int. Cl. H01M 10/0525; C03C 11/00; B65B 29/00

(52) U.S. Cl. CPC H01M 10/0525; B65B 29/00; C03C 11/002

(57) ABSTRACT

Apparatus for transporting used, damaged or defective electrochemical cells while preventing and controlling safety-critical states of the electrochemical cells, such as lithium ion-based cells and/or lithium ion polymer cells, having an outer surrounding wall, a base and a cover which can be closed, which surrounding wall, base and cover define a chamber between them. An intermediate chamber is filled with a fire-retardant material which is composed of only inert, non-conductive and non-combustible and absorbent hollow glass granules as bulk material, and a basket which is permeable to the fire-retardant material is arranged in the chamber for receiving an electrochemical cell.

The present application claims the priority benefits of International Patent Application No. PCT/EP2015/055806, filed Mar. 19, 2015, and claims benefit of DE 102014103928.9, filed on Mar. 21, 2014.

### BACKGROUND OF THE INVENTION

The invention relates to an apparatus for transporting used, damaged or defective galvanic cells whilst preventing and controlling safety critical conditions of the galvanic cells, particularly lithium ion-based cells and/or lithium ion polymer cells, with a container, which defines a space, wherein the space is filled with a flame retardant of only inert, non-conductive and non-combustible and absorbent hollow glass granulate in the form of a loose filling. The invention also relates to a storage and transport method for used, damaged or defective galvanic cells.

In the present case, within the scope of the invention galvanic cells are understood to be apparatuses for spontaneously converting chemical energy into electrical energy which are divided into three groups:
a) primary cells, colloquially also referred to as a battery. It is characteristic that the cell is charged and can be discharged only once. The discharge is irreversible and the primary cell can no longer be electrically charged.
b) secondary cells, colloquially also referred to as a rechargeable battery. After a discharge, secondary cells can then be recharged by a current direction opposite to the discharge. In particular, lithium ion-based cells come into consideration within the scope of the invention.
c) fuel cells, also referred to as tertiary cells. In the case of these galvanic cells, the chemical energy carrier is provided in a continuous manner externally. This permits a continuous operation which in principle is unrestricted in terms of time.

In principle, the invention can be applied to all three types of galvanic cells, but is directed in particular to the metal ion-based cells and more particularly to the lithium-ion based cells and/or lithium ion polymer cells.

For simplicity, only the term “battery” will be used hereinafter, even when referring to all types of galvanic cells.

Nowadays, lithium ion-based cells are used to an increasing extent in a variety of areas because their capacity in comparison to weight is advantageous. In particular, it is expected that their use in electric vehicles and hybrid vehicles, such as passenger cars or two-wheeled vehicles operated by rechargeable battery, will increase considerably in the future.

When batteries, in particular lithium ion batteries, fail, chemical substances (electrolyte) and particles can leak out of the interior of the battery. This released material is then present in solid, liquid or gaseous form and in combinations, e.g. as particles, dust, film, aerosol, liquid, droplet mist. Moreover, a significant amount of heat can occur as a result of chemical and/or electrical reactions.

This material is in part highly reactive and harmful to health. It is also possible that the released material will ignite causing fires and/or explosions.

Therefore, in almost all lithium ion batteries, for example, lithium hexafluorophosphate is used as the electrolyte which in the event of a battery being damaged can leak out and break down into highly reactive and toxic compounds (hydrofluoric acid etc.).

If, in spite of all safety measures, a safety critical condition arises, counter-measures have to be introduced. If e.g. a fire occurs, then fire-fighting measures and measures for avoiding contamination of the environment are required.

In the present case, safety critical conditions include:
leakage of the electrolyte with possibly time-delayed formation of aggressive and poisonous compounds (e.g. hydrofluoric acid in lithium cells);
heating of the cell beyond the boiling point of the electrolyte;
gas formation;
opening of a safety valve and/or rupture of the housing;
leakage of the gas;
formation of an ignitable gas mixture with the influx of oxygen;
explosion of the gas mixture after ignition on an ignition source internal or external to the cell;
combustion of the components of the galvanic cell with the formation of smoke gases;
spreading of the fire to surrounding materials and devices.

These safety critical conditions in the case of galvanic cells, in particular metal ion-based cells and more particularly preferred lithium ion-based cells, should be prevented or at least extensively inhibited.

DE 10 2006 019 739 B4 discloses a system for extinguishing fires in a hazardous object using an extinguishing agent having at least one storage container for the extinguishing agent, having a pipework system for transporting the extinguishing agent from the storage container to the fire, and having a conveying means for conveying the extinguishing agent from the storage container through the pipework system to the fire. The extinguishing agent used is a hollow round granulate which is resistant to a temperature up to at least 1000 degrees and whose diameter is between 0.1 mm and 5 mm. This system has already proven successful but requires active conveying means, sensors etc. and is thus more likely to be considered for industrial installations.

EP 2 167 439 B1 discloses a use of a flame retardant consisting of a hollow round granulate of hollow glass spheres which is resistant to a temperature up to at least 1000° C., wherein the diameter of the round granulate is between 0.1 mm and 5 mm, for preventive fire protection by sustained application onto the hazardous object and/or sustained filling of the hazardous object with the flame retardant. This idea has also proven successful, but is suitable in particular for the floating application in fuel depots or filling of cable ducts etc.

WO 2011/015411 A1 discloses a method of fighting and/or preventing a fire in one or a plurality of battery cells, preferably lithium ion cells, in which an aqueous solution of a calcium salt and a gel extinguishing agent are used.

WO 2010/149611 A1 discloses a method of safely crushing batteries, comprising the steps of: a) providing one or a plurality of batteries to be crushed; and b) mechanically crushing the batteries provided, wherein the crushing process takes place in the presence of: i) at least one metal flame retardant which is suitable for suppressing or reducing a fire in the batteries; and ii) at least one binding agent which is suitable for binding acids and/or bases.

DE 10 2010 035 959 A1 discloses a transport apparatus for hazardous goods, in particular electrochemical energy storage devices, which can have a safety device and a container for the hazardous goods which is filled with a filling material.

### SUMMARY OF THE INVENTION

The object of the invention is to provide an alternative for transporting and storing used, damaged or defective galvanic cells whilst preventing and controlling safety critical conditions of the galvanic cells, which facilities handling.

In accordance with the invention, it has been recognised that, if arranged in the space there is a basket, which is permeable for the flame retardant for receiving at least one galvanic cell, the process of introducing the batteries into, and in particular lifting them out of, the flame retardant is simplified.

In fact, in this manner it becomes possible to load the batteries in question into the basket from outside of the container and to lower the basket as a whole in the container filled with flame retardant. In a similar manner, it is simple to empty the container, for which purpose only the basket has to be lifted out. In both cases, by reason of the permeability the flame retardant penetrates into (or flows out of) the basket and surrounds the batteries, so that they are embedded (or exposed).

Preferably, the basket is a wire basket which consists optionally of powder coated wire.

Preferably, the basket consists of a non-conductive material.

In order to ensure that the distances from the container walls are maintained, the basket can be provided with spacers. Therefore, the basket has to be introduced only into the container filled with flame retardant. The distances are thus “automatically” maintained, even during transport in spite of shaking and jerking movements.

Furthermore, the basket can be provided with partitions in the interior, in order to form compartments for individual batteries, so that they always maintain the required distance from one another.

In the simplest case, the spacers can be constituted by a bracket construction which is formed e.g. as part of the basket and protrudes outwardly.

The spacers can be arranged on the base and/or on the side walls of the basket, so that the distances from the base and/or the side walls are maintained and these are filled with flame retardant.

The mesh width or size of the openings can be adapted to the size of the flame retardant.

The basket can be provided with holders in order to simplify manual or mechanical handling, e.g. withdrawal. They can be e.g. bracket handles, eyelets etc.

The preferred flame retardant consists merely of hollow glass granulate, i.e. it contains only hollow glass granulate and otherwise no further components. Preferably, the hollow glass granulate is a hollow round granulate or a round granulate provided with hollow regions, which is resistant to a temperature up to at least 1000° C. and preferably has a mean diameter between 0.1 mm and 10 mm. A mean diameter between 0.1 mm and 5 mm is more preferred.

The hollow glass granulate used has a grain size, which is calculated according to the safety risk, and a cavity portion for avoiding ignition by cooling and for extinguishing a fire by suffocation and/or oxygen exclusion and for preventing the formation of an inflammable gas mixture and a grain size, which is calculated according to the safety risk, for preventing an explosion, i.e. an explosive atmosphere, displacing oxygen and preventing ignition sources. Furthermore, it does not have any electrical conductivity whatsoever. Moreover, it is absorbent and thus can absorb electrolytes which have leaked out of the cells.

The system permits the reuse of the granulate without any problems and it is practically wear-free. The flame retardant only has to be replaced when it has been used up or has become contaminated.

The invention also relates to a storage and transport method as claimed in claim 9.

In accordance therewith, the galvanic cells in question are embedded directly and individually in a hollow glass granulate serving as a flame retardant for storage/transport for preventing safety critical conditions in the apparatus described above.

No active monitoring is required for triggering the discharge and/or application of an extinguishing agent.

The storage and/or transport can be performed in a hazardous goods container of appropriate classification, in which the galvanic cells are embedded at a distance from one another as regards height, breadth and depth.

It has been demonstrated that the particular flame retardant of the hollow glass granulates is suitable for storing and transporting used, damaged or defective batteries or galvanic cells, in particular lithium ion-based cells.

The properties of the hollow glass granulates used are stated above and are also used in the embedding procedure. The flame retardant acts by “suffocating” the potential fire because the round granulate is deposited onto the galvanic cells in such a manner as to displace and seal off air according to the close-packing of spheres from a certain layer thickness.

The round granulate consists of an inert glass material. This permits a particularly effective filling, flowing and creeping capability and thus reliable transport properties and coverage of the area of the fire, even in narrow and otherwise poorly accessible areas, such as gaps. Therefore, this also prevents the potential fire from being supplied with oxygen.

Preferably, the storage and/or transport take place in a container (outer peripheral wall) consisting of fireproof material, e.g. a hazardous goods or safety container, in which the batteries are embedded in the hollow glass granulate and optionally are embedded at a distance from one another as regards height, breadth and depth. It has proven to be particularly preferable to maintain a distance of at least approximately 30 mm in each case (height, breadth, depth) in relation to a cell height of approximately 10 mm from one another, in the event that a plurality of lithium ion-based cells are inserted.

A distance of at least 2 cm, preferably 5 to 20 cm, in particular 10 cm, should be maintained between side walls of the outer packing (=peripheral wall) and the lithium ion cells.

The outer packing can consist e.g. of metal of a suitable size, of which the base is covered with a layer of a specific hollow glass granulate having a layer thickness of at least 30 mm, preferably 5 to 20 cm, in particular 10 cm. However, containers consisting of synthetic material are also suitable.

If a plurality of galvanic cells are to be transported, then the galvanic cells should be placed onto this base such that a free space of at least 100 mm remains between the galvanic cells. The free spaces are to be filled with the same specific hollow glass granulate. This first layer of galvanic cells can have further layers of cells placed on it in the same manner. The cells are to be covered at the top with a layer of the specific hollow glass granulate having a layer thickness of at least 100 mm. Therefore, all of the galvanic cells are surrounded on all sides by a layer of the specific hollow glass granulate having a layer thickness of at least 100 mm.

In the event that the cells are ignited, the closed (safety) container prevents the spread of fire and contamination. The hollow glass granulate suffocates a fire which has occurred within a short period of time or does not even allow said fire to develop.

The cells are embedded directly in a quantity of the hollow glass granulate calculated according to the safety risk.

Further features and details of the invention will be apparent from the following description of the drawings.

### BRIEF DESCRIPTION OF THE DRAWINGS

FIG. 1 shows a schematic lateral sectional view of a container in accordance with the invention for collecting, storing and transporting lithium ion batteries, and

FIG. 2 shows the container of FIG. 1 in a plan view in the section taken along line A-A.

### DESCRIPTION OF THE PREFERRED EMBODIMENTS

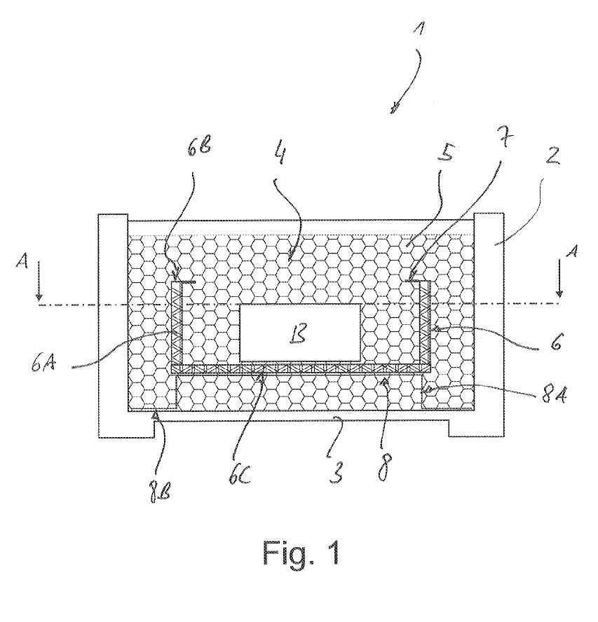

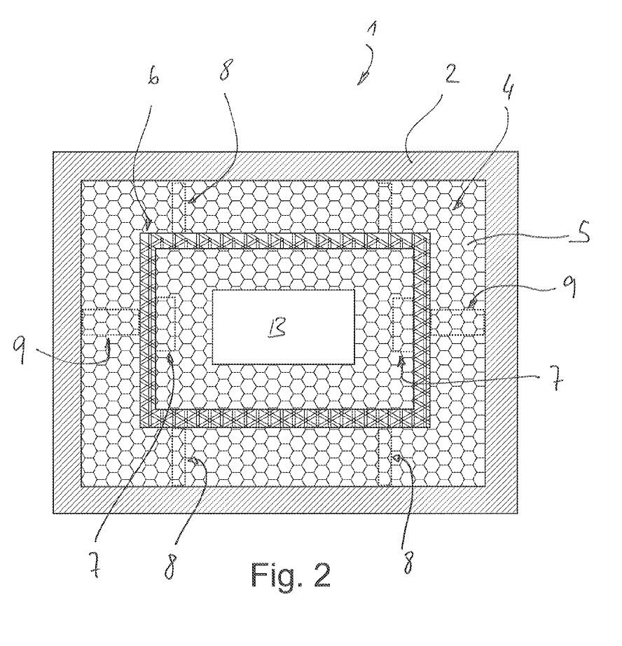

FIGS. 1 and 2 illustrate a closable container consisting of fireproof material and designated in its entirety by the reference sign 1. For improved clarity, the lid provided has been left out of FIGS. 1 and 2.

The container 1 defines by means of an outer wall 2 and a base 3 (and the lid which is not illustrated) in the interior a space 4 which is filled with a filling of hollow glass granulate 5.

The hollow glass granulate 5 is inert, non-conductive and non-combustible and absorbent and only melts at a temperature above at least 1000° C. It has a mean diameter between 0.1 and 5 mm (as per screen analysis).

Inserted into the space 4 is a basket 6 consisting of powder coated wire mesh, of which the mesh width is configured such that the hollow glass granulate 5 can penetrate or flow unhindered through the mesh.

A defective battery B is placed in the basket 6.

Since the hollow glass granulate 5 can flow freely through the mesh of the basket, the battery B is surrounded on all sides by hollow glass granulate 5 or is embedded therein and the risk of uncontrolled occurrence of a critical condition is minimised or prevented.

In order to ensure that the basket 6 can be introduced into and removed from the container 1, it has in each case two bracket handles 7 which protrude inwardly from the upper edge 6B of the basket 6.

Furthermore, the basket is provided on the underside with two spacers 8 which each consist of a wire bracket and are spaced apart in the longitudinal direction of the basket.

The brackets 8 extend initially with a limb 8A from the basket base 6C downwards to the base 3 of the container and thus determine the distance of the basket 6 or the battery B arranged therein from the base.

Then, the brackets 8 extend laterally outwards to the side wall 6A of the container 1, for which reason a further limb 8B bends. Therefore, the basket 6 is also positioned laterally in the container 1 and cannot slip, and so the distance from the side wall 6A is likewise fixed.

The distance of the basket 6 in the remaining container dimension (viewing direction of FIG. 1) is similarly fixed either by the basket 6 itself or further brackets 9 (see FIG. 2, illustrated by broken lines).

The battery B can thus be placed into the basket 6 and the basket can then be introduced into the container 1, wherein already partially introduced hollow glass granulate 5 flows through the mesh of the basket and thus surrounds the battery B. Subsequently, further hollow glass granulate 5 can be added, in order to fill the space 4 in the container 1 completely or up to the desired fill level and cover the battery B.

### LIST OF REFERENCE SIGNS

1 hazardous goods container
2 wall
3 base
4 space
5 hollow glass granulate
6 basket
6A side wall of the basket
6B edge of the basket
6C basket base
7 bracket handle
8 bracket
8A limb
8B limb
9 bracket
B lithium ion polymer battery module

1. An apparatus for transporting used, damaged or defective galvanic cells while preventing and controlling safety critical conditions of the galvanic cells, said apparatus comprising a container, which defines a space, wherein the space is filled with a flame retardant of only inert, non-conductive and non-combustible and absorbent hollow glass granulate in the form of a loose filling, and wherein arranged in the space there is a basket, which is permeable for the flame retardant for receiving at least one galvanic cell.

2. The apparatus as claimed in claim 1, wherein the basket is a wire basket.

3. The apparatus as claimed in claim 2, wherein the basket consists of powder coated wire.

4. The apparatus as claimed in claim 3, wherein the basket is provided with spacers.

5. The apparatus as claimed in claim 4, wherein the spacers are constituted by a bracket construction.

6. The apparatus as claimed in claim 5, wherein the spacers are arranged on the base and/or on the side walls of the basket.

7. The apparatus as claimed in claim 6, wherein the hollow glass granulate is a hollow round granulate or a round granulate provided with hollow regions, which is resistant to a temperature up to at least 1000° C. and has a mean diameter between 0.1 mm and 10 mm.

8. The apparatus as claimed in claim 6, wherein the apparatus further comprises an outer peripheral wall, and wherein the outer peripheral wall comprises a conventional hazardous goods container.

9. (canceled)

10. (canceled)

11. The apparatus as claimed in claim 1, wherein the basket is provided with spacers.

12. The apparatus as claimed in claim 11, wherein the spacers are constituted by a bracket construction.

13. The apparatus as claimed in claim 12, wherein the spacers are arranged on the base and/or on the side walls of the basket.

14. The apparatus as claimed in claim 1, wherein the apparatus further comprises an outer peripheral wall, and wherein the outer peripheral wall comprises a conventional hazardous goods container.

15. The apparatus as claimed in claim 1, wherein the hollow glass granulate is a hollow round granulate or a round granulate provided with hollow regions.

16. The apparatus as claimed in claim 15, wherein the hollow glass granulate has a mean diameter between 0.1 mm and 10 mm.

17. The apparatus as claimed in claim 16, wherein the hollow glass granulate has a mean diameter between 0.1 mm and 5 mm.

18. The apparatus as claimed in claim 15, wherein the hollow glass granulate is resistant to a temperature up to at least 1000° C.

19. A method of storing and transporting used, damaged or defective galvanic cells for preventing safety critical conditions, said method comprising:
directly embedding one or more used, damaged or defective galvanic cells in a flame retardant contained in an apparatus, wherein the flame retardant comprises only inert, non-conductive and non-combustible and absorbent hollow glass granulate in the form of a loose filling, wherein the apparatus comprises a container, which defines a space, and wherein the space is filled with the hollow glass granulate, and wherein the apparatus further comprises a permeable basket arranged in the space with the basket being permeable for the hollow glass granulate; and
storing and/or transporting the galvanic cell in the apparatus/

20. The method of claim 19, wherein the step of directly embedding the galvanic cell comprises directly and individually embedding a plurality of galvanic cells in the flame retardant.

21. The method of claim 20, wherein the step of storing and/or transporting is performed in a hazardous goods container of appropriate classification, in which the galvanic cells are embedded at a distance from one another as regards height, breadth and depth.

22. The method of claim 19, wherein the galvanic cells comprise lithium ion-based cells.
